(19) United States
(12) Patent Application Publication
(10) Pub. No.: US 2026/0327917 A1
(43) Pub. Date: Oct. 22, 2026

(54) Cementitious Base Composition for Surface Materials

(71) Applicant: Matthew Levene Ledlow, Windermere, FL (US)

(72) Inventor: Matthew Levene Ledlow, Windermere, FL (US)

(21) Appl. No.: 19/652,510

(22) Filed: Apr. 20, 2026

Related U.S. Application Data
(60) Provisional application No. 63/791,295, filed on Apr. 18, 2025.

(51) Int. Cl. E01C 7/14; C04B 14/06; C04B 24/24; C04B 28/04; C04B 40/06; C04B 103/00; C04B 103/10; C04B 103/50; C04B 103/60; C04B 111/00

(52) U.S. Cl. CPC E01C 7/142; C04B 14/062; C04B 24/24; C04B 28/04; C04B 40/0608; C04B 2103/0054; C04B 2103/10; C04B 2103/50; C04B 2103/601; C04B 2111/00094

(57) ABSTRACT

A dry cementitious base composition for installation of hardscape surface materials includes ultrafine sand in an amount of 40% to 60% by weight, cement in an amount of 25% to 45% by weight, fine sand in an amount of 10% to 20% by weight, a redispersible polymer in an amount of 1% to 3.5% by weight, a specialty cement in an amount of 1.5% to 4.5% by weight, a defoamer in an amount of 0% to 2% by weight, an accelerator in an amount of 0% to 2% by weight, a densifier in an amount of 0% to 2% by weight, a pozzolan in an amount of 0% to 4% by weight, a sag resistance additive in an amount of 0% to 1% by weight, and micro-silica in an amount of 0% to 4% by weight.

### RELATED APPLICATION

The present application claims priority to U.S. provisional patent application Serial No. 6 63/791,295, entitled Cementitious Base Composition For Surface Materials, filed on Apr. 18, 2025, the contents of which are herein incorporated by reference.

### TECHNICAL FIELD

The present invention relates to cementitious base compositions and, more particularly, to an advanced-formulated, dry multi-component cementitious base material for use in the landscape, hardscape, and decorative applications, indoors or outdoors.

### BACKGROUND

The installation of hardscape surface materials (e.g., paving stones, natural stone, porcelain, travertine, tile, and marble) for walkways, driveways, pool decks, patios, and other decorative surfaces presents persistent technical challenges, including paving stone movement, vegetation growth, insect colonization, water wash-out, inadequate drainage, and the inability to support heavier or more fragile stone materials under significant load.

Conventional installation methods each address some of these challenges but none address all of them. Compacted earth or standard paver base alone provides no resistance to paving stone movement, vegetation growth, wash-out, or insect colonization. Single-component materials such as joint sand, mason sand, or ordinary Portland cement, when used alone, exhibit low compressive and flexural strength, rendering them similarly ineffective. Ready-mixed or bagged concrete products can provide greater structural strength, but require lengthy curing times, significant cost and equipment, are prone to leveling and drainage problems, and suffer from product variability. Rigid plastic underlayment panels offer reasonable consistency but are costly, environmentally problematic, and inadequate for heavier stone materials or high-traffic areas.

A limitation shared by substantially all conventional methods is the inability to support larger, heavier, or more fragile paving materials (e.g., travertine, porcelain, natural stone, and marble) which require sufficient compressive and flexural strength to prevent cracking and failure. Accordingly, there is a need in the art for a cementitious base composition that provides high compressive, tensile, and flexural strength; resists paving stone movement, vegetation growth, water wash-out, and insect colonization; allows for appropriate drainage; and is suitable for a broad range of paving materials under varying load conditions.

### SUMMARY

The present disclosure relates to a dry multi-component cementitious base composition (CBC) for use in the installation of hardscape surface materials, including paving stones, natural stone, porcelain, travertine, tile, and marble, for applications such as walkways, driveways, pool decks, patios, and other decorative surfaces, indoors or outdoors. In various embodiments, the CBC comprises a structural matrix of ultrafine sand, cement, and fine sand, combined with a plurality of functional additives including a redispersible polymer, a specialty cement, a defoamer, an accelerator, a densifier, a pozzolan, a sag resistance additive, and micro-silica. The CBC is formulated and packaged as a dry, unactivated powder that is distributed over a prepared sub-base in its dry state and activated in situ by water saturation following placement of the hardscape surface material thereover, thereby eliminating the need for on-site water mixing or concrete formwork prior to surface material installation.

Upon activation and curing, the CBC forms a solid, monolithic substrate that provides high compressive, tensile, and flexural strength sufficient to support a broad range of hardscape surface materials, including heavier and more fragile materials that require a rigid, high-strength base to prevent cracking and structural failure under load. The cured CBC also resists paving stone movement, vegetation growth, water wash-out, and insect colonization throughout the service life of the hardscape installation. In various embodiments, the CBC is adaptable to a wide range of environmental and structural installation conditions through the selective addition of one or more supplementary, specialty components, including an antifreeze additive for cold-weather and freeze-thaw environments, a decelerator for extended working time in high-temperature conditions, a coarse aggregate for enhanced load-bearing capacity under heavy vehicular traffic, mortar fiber for increased flexural toughness, and a plasticizer for reduced water demand and improved matrix density.

The present disclosure also relates to methods of installing hardscape surface materials using the CBC. In various embodiments, a method of installation comprises preparing and compacting a sand base layer, distributing the dry CBC over the sand base layer, optionally positioning reinforcing members within the distributed composition, screeding the composition to a level surface, laying the hardscape surface material in a desired pattern, setting border elements at the lateral perimeter of the installation area, and activating the CBC by saturating the hardscape surface material with water. The activated CBC undergoes hydraulic hardening over a curing period and bonds to the overlying hardscape surface material, producing a structurally integrated hardscape installation that achieves the performance properties of more complex and costly conventional methods while maintaining installation timelines and simplicity comparable to conventional sand-based approaches.

In Example 1, a dry cementitious base composition for installation of hardscape surface materials comprises: ultrafine sand in an amount of about 40% to about 60% by weight; cement in an amount of about 25% to about 45% by weight; fine sand in an amount of about 10% to about 20% by weight; a redispersible polymer in an amount of about 1% to about 3.5% by weight; a specialty cement in an amount of about 1.5% to about 4.5% by weight; a defoamer in an amount of 0% to about 2% by weight; an accelerator in an amount of 0% to about 2% by weight; a densifier in an amount of 0% to about 2% by weight; a pozzolan in an amount of 0% to about 4% by weight; a sag resistance additive in an amount of 0% to about 1% by weight; and micro-silica in an amount of 0% to about 4% by weight.

In Example 2, the dry cementitious base composition of Example 1 is provided wherein the composition is configured for dry placement over a prepared substrate and activation by water saturation following placement of surface materials thereon.

In Example 3, the dry cementitious base composition of Example 1 is provided wherein the cement comprises at least one of ordinary Portland cement (OPC) and Portland limestone cement (PLC).

In Example 4, the dry cementitious base composition of Example 1 is provided wherein the defoamer is in an amount of about 0.001% to about 2% by weight.

In Example 5, the dry cementitious base composition of Example 1 is provided wherein the accelerator is in an amount of about 0.001% to about 2% by weight.

In Example 6, the dry cementitious base composition of Example 1 is provided wherein the densifier is in an amount of about 0.001% to about 2% by weight.

In Example 7, the dry cementitious base composition of Example 1 is provided wherein the pozzolan is in an amount of about 0.001% to about 4% by weight.

In Example 8, the dry cementitious base composition of Example 1 is provided wherein the sag resistance additive is in an amount of about 0.001% to about 1% by weight.

In Example 9, the dry cementitious base composition of Example 1 is provided wherein the micro-silica is in an amount of about 0.001% to about 4% by weight.

In Example 10, the dry cementitious base composition of Example 1 is provided further comprising an antifreeze additive in an amount of about 0.001% to about 1% by weight.

In Example 11, the dry cementitious base composition of Example 1 is provided further comprising a decelerator in an amount of about 0.001% to about 4% by weight.

In Example 12, the dry cementitious base composition of Example 1 is provided further comprising a coarse aggregate in an amount of about 5% to about 10% by weight.

In Example 13, the dry cementitious base composition of Example 1 is provided further comprising a mortar fiber in an amount of about 0.001% to about 2% by weight.

In Example 14, the dry cementitious base composition of Example 1 is provided further comprising a plasticizer in an amount of about 0.001% to about 2% by weight.

In Example 15, a method of installing hardscape surface materials over a prepared substrate comprises: compacting and screeding a sand base layer over a prepared ground substrate; distributing a dry cementitious base composition over the compacted sand base layer, wherein the composition comprises ultrafine sand, cement, fine sand, a redispersible polymer, a specialty cement, and one or more additives selected from the group consisting of a defoamer, an accelerator, a densifier, a pozzolan, a sag resistance additive, and micro-silica; lightly compacting and screeding the distributed composition to achieve a level surface; laying surface materials on top of the dry cementitious base composition in a desired pattern; setting a border element around the surface materials; and saturating the surface materials with water to activate the cementitious base composition and initiate bonding and setting thereof.

In Example 16, the method of Example 15 is provided further comprising positioning rebar atop the distributed dry cementitious base composition.

In Example 17, the method of Example 15 is provided wherein the dry cementitious base composition comprises: the ultrafine sand in an amount of about 40% to about 60% by weight; the cement in an amount of about 25% to about 45% by weight; the fine sand in an amount of about 10% to about 20% by weight; the redispersible polymer in an amount of about 1% to about 3.5% by weight; the specialty cement in an amount of about 1.5% to about 4.5% by weight; the defoamer in an amount of 0% to about 2% by weight; the accelerator in an amount of 0% to about 2% by weight; the densifier in an amount of 0% to about 2% by weight; the pozzolan in an amount of 0% to about 4% by weight; the sag resistance additive in an amount of 0% to about 1% by weight; and the micro-silica in an amount of 0% to about 4% by weight.

In Example 18, the method of Example 17 is provided wherein: the defoamer is in an amount of 0.001% to about 2% by weight; the accelerator is in an amount of 0.001% to about 2% by weight; the densifier is in an amount of 0.001% to about 2% by weight; the pozzolan is in an amount of 0.001% to about 4% by weight; and/or the sag resistance additive is in an amount of 0.001% to about 1% by weight.

In Example 19, the method of Example 17 is provided wherein the dry cementitious base composition further comprises one or more specialty additives as follows: an antifreeze additive in an amount of about 0.001% to about 1% by weight; a decelerator in an amount of about 0.001% to about 4% by weight; a coarse aggregate in an amount of about 5% to about 10% by weight; a mortar fiber in an amount of about 0.001% to about 2% by weight; a plasticizer in an amount of about 0.001% to about 2% by weight; and/or a micro-silica in an amount of 0.001% to about 4% by weight.

In Example 20, a method of forming a hardscape installation capable of supporting travertine, porcelain, natural stone, tile, or marble surface materials comprises: applying a compacted sand layer over a prepared ground substrate; dry-applying over the sand layer a multi-component cementitious base composition comprising ultrafine sand, cement, fine sand, a redispersible polymer, a specialty cement, a densifier, a pozzolan, and micro-silica; screeding the dry cementitious base composition to a uniform depth; placing the surface materials on top of the dry cementitious base composition; and activating the composition by saturating the surface materials with water and allowing the composition to cure to form a solid substrate.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 is a cross-section of a hardscape installation, in accordance with embodiments of the present disclosure.

FIG. 2 is a flowchart of a method of making the hardscape installation, in accordance with embodiments of the present disclosure.

FIGS. 3A-3F are formulation tables of variations of the cementitious base composition of the hardscape installation, in accordance with embodiments of the present disclosure.

While the disclosure is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

For purposes of promoting an understanding of the principles of the present disclosure, reference is now made to the examples illustrated in the drawings, which are described below. The illustrated examples disclosed herein are not intended to be exhaustive or to limit the disclosure to the precise form disclosed in the following detailed description. Rather, these exemplary embodiments were chosen and described so that others skilled in the art may use their teachings. It is not beyond the scope of this disclosure to have a number (e.g., all) the features in a given example used across all examples. Thus, no one figure should be interpreted as having any dependency or requirement related to any single component or combination of components illustrated therein. Additionally, various components depicted in a given figure may be, in examples, integrated with various ones of the other components depicted therein (and/or components not illustrated), all of which are considered to be within the ambit of the present disclosure.

As used herein, the term “accelerator” is intended to mean or refer to an additive for cementitious mixes, that can be of a tremendous variation of raw material types including inorganic compounds of lithium or calcium variations, that is blended with the intention of speeding up or lowering the set time of the blended compound during use.

As used herein, the term “antifreeze additive” is intended to mean or refer to an additive that can be blended into concrete or mortar mixes with the intention of assisting the mix to set at lower temperatures and/or reduce/eliminate the effects of freeze-thaw.

As used herein, the term “cement” is intended to mean or refer to a dry powder binder used for construction purposes that when blended with other ingredients can be made into concrete, mortar, plaster, and many other useful compounds.

As used herein, the term “cementitious” is intended to mean or refer to having the nature of, comprised of, or containing cement.

As used herein, the term “compressive strength” is intended to mean or refer to the ability for an item, substance, or surface to withstand loads in a pressing manner.

As used herein, the term “concrete” is intended to mean or refer to a multi-component material that is composed of a binder (in this document cement) and an aggregate usually placed when exposed to water via the hydraulic properties of cement.

As used herein, the term “decelerator” is intended to refer to, and is often termed “set retarders” or “retarders”, a component that can be added to a cementitious mixture with the intention of slowing down or increasing the set time of the blended compound during use.

As used herein, the term “defoamer” is intended to mean or refer to an additive that can be blended into concrete or mortar mixes with the intention of eliminating gas and/or air pockets within the finished placed cementitious mixture.

As used herein, the term “densifier” is intended to mean or refer to a chemical compound that can be topically applied to a finished surface or used as an additive within a cementitious mixture with the intention of increasing the durability and density within the finished placed cementitious mixture.

As used herein, the term “excavation” is intended to mean or refer to the construction process by which, usually through the means of equipment, an area of ground is dug into or hollowed out to a depth necessary (often a few inches) to provide a level surface suited to the next phase of a specific process, such as slab, path, or pad work.

As used herein, the term “flexural strength” is intended to mean or refer to the ability for an item, substance, or surface to withstand loads in a twisting or bending manner.

As used herein, the term “industry” is intended to mean or refer to a sector of the business economy consisting of businesses with like enterprise products, customers, vendors, and/or intent.

As used herein, the term “marble” is intended to mean or refer to a natural occurring mineral rock that is sought for its aesthetic appeal and cut to make pieces utilized in numerous areas within building construction, including paving stones, wall pieces, countertops, and architectural elements.

As used herein, the term “mortar” is intended to mean or refer to a multi-component material that is composed of a binder (in this document cement) and a fine and/or ultra-fine aggregate usually placed when exposed to water via the hydraulic properties of cement.

As used herein, the term “mortar fiber” is intended to mean or refer to small shredded fibers made of synthetic, steel, or natural materials blended into cementitious mixtures with in the intention of increasing the performance properties during final use.

As used herein, the term “natural stone” is intended to mean or refer to any naturally occurring mineral rock, including granite, flagstone, and marble that is sought for its aesthetic appeal and cut to make pieces utilized in numerous areas within building construction, including paving stones, wall pieces, countertops, and architectural elements.

As used herein, the term “paver or paving stone” is intended to mean or refer to any piece of natural stone, porcelain, tile, concrete, or other material placed in patterns with the intention of forming flat surfaces for walkways, driveways, courtyards, pool patios, lanais, or other such areas requiring such for practical and/or aesthetic purposes.

As used herein, the term “plasticizer” is intended to mean or refer to an additive, also known as superplasticizers, water reducers, or high range water reducers, that is blended into cementitious mixes with the intention of reducing water requirements which can positively affect specific performance characteristics during final use.

As used herein, the term “porcelain” is intended to mean or refer to a manufactured ceramic product often consisting of clay and other subcomponents that can be used to make pieces utilized in numerous areas within building construction, including paving stones, wall pieces, and architectural elements.

As used herein, the term “pozzolan” is intended to mean or refer to a highly varied set of materials which, in supplementation, replacement, or independent of hydraulic cementitious materials, can provide positive characteristic improvement, ranging from chemical to financial.

As used herein, the term “prototype formulation” is intended to mean or refer to an original formulation of a compound which can be used as a working form of the product and may or may not become a finalized formulation.

As used herein, the term “redispersible polymer” is intended to mean or refer to a dry polymer emulsion, usually created by spray drying manufacturing processes that are used in cementitious mortar compounds and when mixed with water can disperse back into an emulsion with the mortar compound providing characteristics of adhesion, cohesion, and flexibility.

As used herein, the term “retarder” is intended to mean or refer to an additive for cementitious mixes, that can be of a tremendous variation of raw material types including sugars and phosphonate variations, that is blended with the intention of speeding up or lowering the set time of the blended compound during use.

As used herein, the term “sag resistance” is intended to mean or refer to a characteristic or property of cementitious compounds that identifies that compounds ability to relates to resist movement under loaded pressure.

As used herein, the term “set time” is intended to mean or refer to the amount of time it takes a cementitious mixture following its blending with water to reach an established level of hardness.

As used herein, the term “tensile strength” is intended to mean or refer to the ability for an item, substance, or surface to withstand loads in a pulling manner.

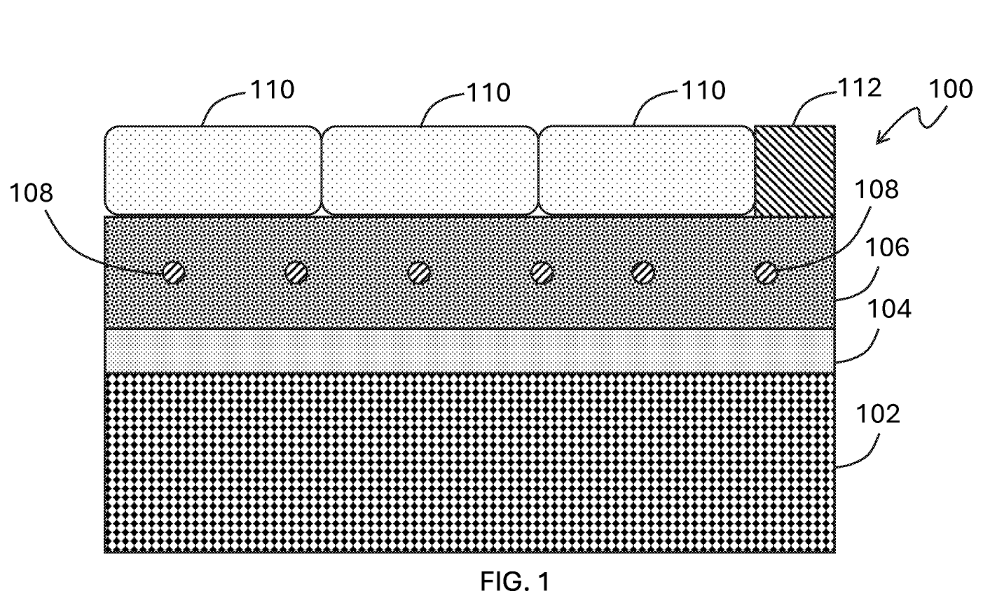

FIG. 1 is a cross-section of a hardscape installation 100. In the illustrated embodiment, the hardscape installation 100 includes a native ground 102, a compacted sand layer 104, a cementitious base composition (CBC) 106, rebar 108, a hardscape surface material (HSM) 110, and a border element 112. The hardscape installation 100 is arranged as a layered structure that extends vertically from the native ground 102 upward to the HSM 110.

In the illustrated embodiment, the compacted sand layer 104 is disposed directly above and in contact with the native ground 102. The CBC 106 is disposed directly above and in contact with the compacted sand layer 104. The optional rebar 108 is embedded within the CBC 106, and the rebar 108 can include bar stock, welded wire mesh/fabric, and/or conventional rebar. The HSM 110 is disposed directly above and in contact with the CBC 106. The border element 112 is positioned at the perimeter of the hardscape installation 100 and laterally constrains the CBC 106 and the HSM 110.

In the illustrated embodiment, the native ground 102 serves as the foundation substrate upon which all subsequent layers of the hardscape installation 100 are built. The compacted sand layer 104 is laid and compacted directly atop the native ground 102 to provide a level, stable, and load-distributing sub-base. In some embodiments, the thickness of the compacted sand layer 104 is between about 1.2 cm to about 18 cm or between about 2.5 cm to about 10 cm.

In the illustrated embodiment, the CBC 106 is applied atop the compacted sand layer 104 and forms the structural core of the hardscape installation 100. In some embodiments, the rebar 108 is embedded within the CBC 106 during installation and functions as internal reinforcement, providing the CBC 106 with tensile strength to resist cracking, settling, and deformation under load. In some embodiments, the rebar 108 is a steel reinforcing bar arranged in a pattern (e.g., parallel array or a grid) within the plane of the CBC 106. In some embodiments, the thickness of the CBC 106 is between about 1.2 cm to about 7.6 cm.

In the illustrated embodiment, the HSM 110 is disposed atop the CBC 106 and forms the visible, walkable surface of the hardscape installation 100. In some embodiments, the HSM 110 is a paving material such as an array of concrete pavers, natural stone, brick, and/or tile. In some embodiments, the thickness of the HSM 110 is between about 1.2 cm to about 6.4 cm. The border element 112, positioned at the lateral perimeter of the hardscape installation 100, is a structural edge element that operates to contain and stabilize the CBC 106 and HSM 110 against lateral displacement. In some embodiments, the border element 112 is a rigid material such as concrete, steel edging, or composite material.

Taken together, the layered arrangement of the hardscape installation 100 provides a structurally integrated system that distributes surface loads through the layers to the native ground 102. The technical significance of this arrangement is that the CBC 106 and embedded rebar 108 cooperate to form a reinforced structural base that resists cracking and movement, while the compacted sand layer 104 accommodates minor variations in the native ground 102 and provides a consistent bearing surface for the CBC 106.

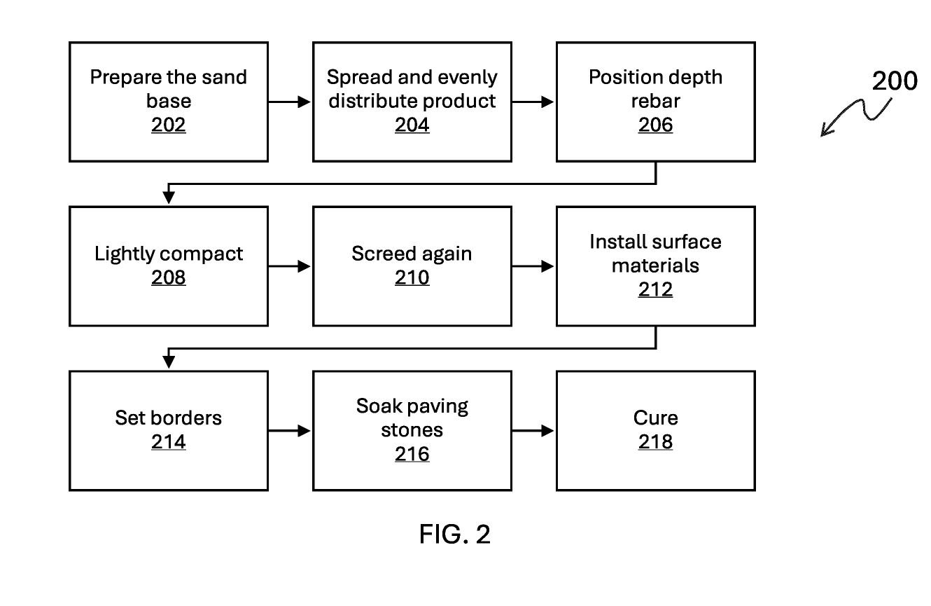

FIG. 2 is a flowchart of a method 200 of making the hardscape installation 100. In discussing the method 200, references will be made to the elements shown in FIG. 1. In the illustrated embodiment, the method 200 includes nine sequential steps: a sand base preparation step 202, a product distribution step 204, a rebar positioning step 206, a compaction step 208, a screeding step 210, a surface material installation step 212, a border setting step 214, a saturation step 216, and a curing step 218. As shown, the steps 202-218 are connected by directional flow indicators that establish a prescribed order of execution from first to last through one embodiment of the method 200.

In the illustrated embodiment, the sand base preparation step 202 is the first step of the method 200. During the sand base preparation step 202, the compacted sand layer 104 is compacted and screeded to create a level, stable sub-base over the native ground 102 (e.g., ground substrate that has been excavated and prepared for the hardscape installation 100). In some embodiments, (e.g., pool decks) the surface of the sand layer 104 is 13 mm lower than the desired depth for the CBC 106, and in some embodiments (e.g., driveways) the surface of the sand layer 104 is 25 mm lower than the desired depth for the CBC 106. Following the sand base preparation step 202, the product distribution step 204 is performed, in which the dry CBC 106 is spread evenly over the compacted sand layer 104 across the entire installation area. A benefit of the product distribution step 204 is that the CBC 106 is distributed in its dry, unactivated powder form (i.e., without mixing with water). In some embodiments, the CBC 106 is distributed to a substantially uniform depth across the installation area to ensure consistent structural performance of the finished hardscape installation 100. In some embodiments, the CBC 106 is packaged in conventional “mortar bags” (usually multi-wall, paper or polypropylene bags) that are filled by metering machines via valves or open points. Such bags are easy to transport, and they are easily opened and poured from directly onto the compacted sand layer 104.

In the illustrated embodiment, following and/or during the product distribution step 204, the rebar positioning step 206 is performed, in which the rebar 108 is positioned atop the distributed CBC 106 at a desired depth within the installation area. In some embodiments, different sizes of rebar 108 are selected to achieve different levels of tensile reinforcement depending on the size, weight, and type of HSM 110 to be supported. Following the rebar positioning step 206, the compaction step 208 is performed, in which the CBC 106 is lightly compacted using a screeding tool to consolidate the composition and create a stable working surface. The compaction step 208 is followed by the screeding step 210, in which the CBC 106 is screeded again to produce a planar and level surface across the installation area. Together, the compaction step 208 and the screeding step 210 cooperate to establish the uniform surface profile upon which the HSM 110 is to be laid.

In the illustrated embodiment, following the screeding step 210, the surface material installation step 212 is performed, in which the HSM 110 is laid atop the dry, level CBC 106 in a desired pattern. At this stage of the method 200, the CBC 106 remains in its dry, unactivated state beneath the HSM 110. Following the surface material installation step 212, the border setting step 214 is performed, in which the border element 112 is secured at the lateral perimeter of the installation area. In the illustrated embodiment, the border element 112 is set using standard concrete methodology to laterally constrain the CBC 106 and the HSM 110 and to resist lateral displacement of the hardscape installation 100 following curing.

In the illustrated embodiment, following the border setting step 214, the saturation step 216 is performed, in which the HSM 110 is thoroughly saturated with water. The water permeates downward through the HSM 110 and into the CBC 106, activating the hydraulic and polymer chemistry of the CBC 106 and initiating bonding and setting at the interface between the CBC 106 and the HSM 110. The saturation step 216 is the activation mechanism of the method 200 and represents a distinguishing aspect of the dry-placement approach in that the CBC 106 is applied in a dry state and activated in situ by water permeating downward through the HSM 110, rather than being pre-mixed with water before placement.

Following the saturation step 216, the curing step 218 is performed as the final step of the method 200. In the illustrated embodiment, the curing step 218 requires a minimum of 48 hours before any foot or vehicular traffic is permitted over the HSM 110. During the curing step 218, the activated CBC 106 undergoes hydraulic hardening, during which the composition develops the compressive, tensile, and flexural strength properties necessary to support the HSM 110 and applied surface loads. Upon completion of the curing step 218, the CBC 106 forms a solid, monolithic substrate that resists movement of the HSM 110, vegetation growth, water wash-out, and insect colonization throughout the hardscape installation 100.

Taken together, the sequential steps of the method 200 produce the completed hardscape installation 100 shown in FIG. 1. The technical significance of the method 200 is that the dry-placement approach in which the CBC 106 is spread, profiled, and embedded with the rebar 108 in a dry state, and then activated only after the HSM 110 is in its final position. Doing so eliminates the need for on-site water mixing, concrete formwork, or extended pre-curing intervals between preparation and surface material installation. This approach enables installation timelines comparable to conventional sand-based methods while achieving the structural performance necessary to support demanding surface materials such as travertine, porcelain, natural stone, tile, and marble. In some embodiments, subsequent addition of water, for example, from rain, can activate any residual dry CBC 106 that was not reached during the saturation step 216, which further consolidates the CBC 106 and reduces the potential for water wash-out over time.

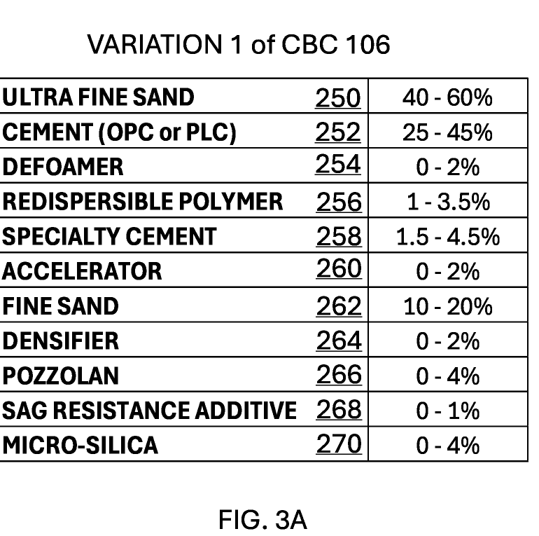

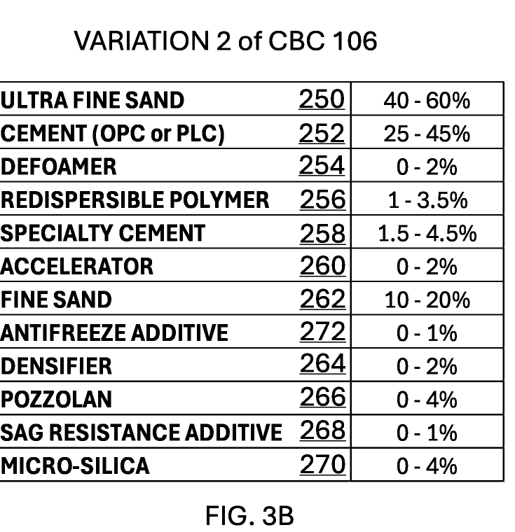

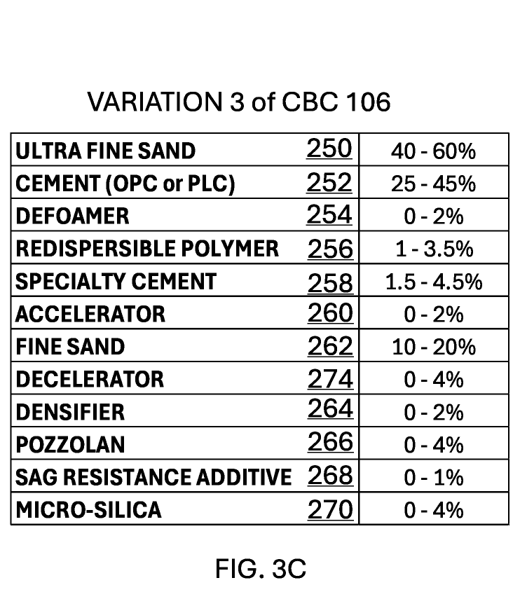

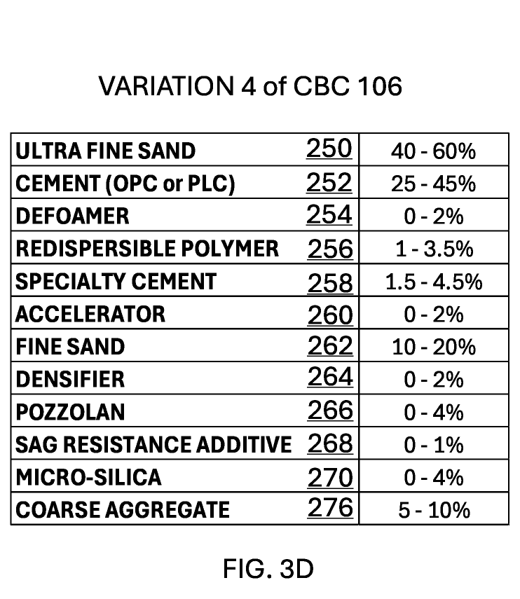

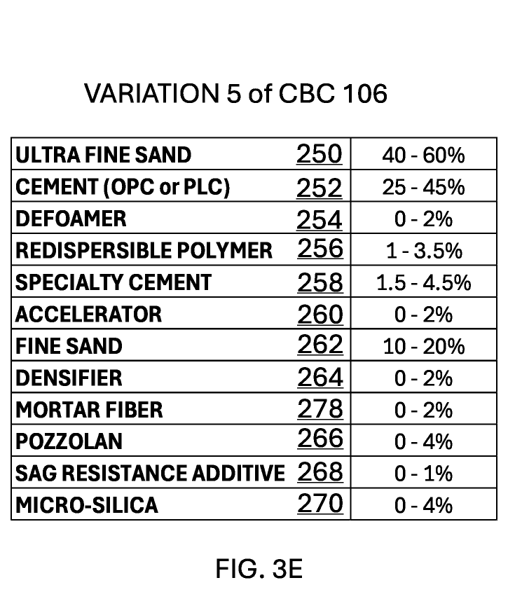

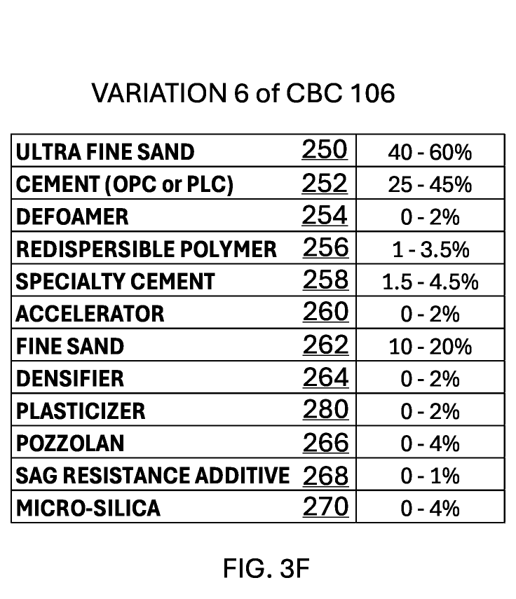

FIGS. 3A-3F are formulation tables of variations of the cementitious base composition (CBC) 106. FIG. 3A is a formulation table of a first variation of the CBC 106, referred to herein as Variation 1. In the illustrated embodiment, Variation 1 of the CBC 106 includes eleven constituent components: ultrafine sand 250, cement 252, a defoamer 254, a redispersible polymer 256, a specialty cement 258, an accelerator 260, fine sand 262, a densifier 264, a pozzolan 266, a sag resistance additive 268, and micro-silica 270. The CBC 106 is a dry multi-component cementitious powder that is packaged and distributed in its dry, unactivated state, and that is activated in situ by water saturation, for example, following placement of the HSM 110 thereover, as described above in connection with FIG. 2.

In the illustrated embodiment, the ultrafine sand 250, the cement 252, and the fine sand 262 collectively constitute the primary structural matrix of the CBC 106. The ultrafine sand 250 is present in an amount of about 40% to about 60% by weight and functions as the dominant aggregate component of the CBC 106. In some embodiments, the ultrafine sand 250 is a fine silica quartz sand or manufactured sand having a particle size smaller than 40 mesh. The cement 252 is present in an amount of about 25% to about 45% by weight and serves as the primary hydraulic binder that, upon activation with water, undergoes hydraulic hardening to produce the compressive, tensile, and flexural strength of the cured CBC 106. In some embodiments, the cement 252 is ordinary Portland cement (OPC) Type I/II, OPC Type III, or Portland limestone cement (PLC) Type 1L. The fine sand 262 is present in an amount of about 10% to about 20% by weight and serves as a coarser aggregate fraction that complements the ultrafine sand 250 to optimize particle packing density and workability of the dry composition during distribution and screeding. In some embodiments, the fine sand 262 is a silica quartz sand or manufactured sand having a particle size between 10 and 40 mesh.

In the illustrated embodiment, the remaining eight components of Variation 1 are functional additives that are blended into the structural matrix to impart specific performance properties upon activation and curing. The defoamer 254 is present in an amount of about 0% to about 2%, about 0.001% to about 2%, about 0.01% to about 2% or about 0.1% to about 2% by weight. Upon activation with water, the defoamer 254 operates to eliminate gas and/or air pockets within the activated CBC 106, thereby increasing the density and homogeneity of the cured composition and reducing voids that could compromise structural integrity. In some embodiments, the defoamer 254 is a powder defoamer/deaerator such as BASF Foamaster, Ashland Drew/Drewplus, Fritz-Pak Airminus, or Eucon Air-Down. The redispersible polymer 256 is present in an amount of about 1% to about 3.5% by weight. In the illustrated embodiment, the redispersible polymer 256 is a dry polymer emulsion produced by spray-drying that, upon activation with water, re-disperses back into a polymer emulsion within the CBC 106 matrix. In some embodiments, the redispersible polymer 256 is a product such as Celanese Elotex, Dow DLP, Wacker Vinnapas, or Orgachem Organik redispersible powder polymer. The dispersed polymer operates to provide the cured CBC 106 with increased adhesion to the compacted sand layer 104 and to the HSM 110, cohesion within the cured matrix, and a degree of flexibility that reduces susceptibility to cracking under load.

The specialty cement 258 is present in an amount of about 1.5% to about 4.5% by weight and functions as a supplemental binder that, in combination with the cement 252, enhances early-strength development and bonding characteristics of the CBC 106 upon activation. In some embodiments, the specialty cement 258 is calcium sulfoaluminate cement, calcium aluminate cement, refractory cement, or magnesium phosphate cement. The accelerator 260 is present in an amount of about 0% to about 2%, about 0.001% to about 2%, about 0.01% to about 2%, or about 0.1% to about 2% by weight and operates to reduce the set time of the CBC 106 following water activation, enabling the cured CBC 106 to develop structural strength more rapidly and shortening the minimum curing period before the hardscape installation 100 is placed in service. In some embodiments, the accelerator 260 is lithium carbonate, calcium aluminate, or calcium chloride.

The densifier 264 is present in an amount of about 0% to about 2%, about 0.001% to about 2%, about 0.01% to about 2%, or about 0.1% to about 2% by weight and operates to increase the durability and density of the cured CBC 106 by filling microscopic voids within the cementitious matrix, thereby improving compressive strength and reducing permeability. In some embodiments, the densifier 264 is colloidal silica. The pozzolan 266 is present in an amount of about 0% to about 4%, about 0.001% to about 4%, about 0.01% to about 4%, or about 0.1% to about 4% by weight and functions as a supplementary cementitious material that reacts with calcium hydroxide generated during cement hydration to produce additional cementitious binding compounds, which further strengthen and densify the cured CBC 106. In some embodiments, the pozzolan 266 is fly ash, slag, or silica fume. The sag resistance additive 268 is present in an amount of about 0% to about 1%, about 0.001% to about 1%, about 0.01% to about 1%, or about 0.1% to about 1% by weight and operates to resist movement of the CBC 106 under loaded pressure during and following placement, prior to full curing. In some embodiments, the sag resistance additive 268 is a stabilizer/thickener such as BASF Starvis, Nouryon Bermocall, or Elementis Benaqua. The micro-silica 270 is present in an amount of about 0% to about 4%, about 0.001% to about 4%, about 0.01% to about 4%, or about 0.1% to about 4% by weight. In some embodiments, the micro-silica 270 is silica with a particle size smaller than 1200 mesh. The micro-silica 270 functions as both an ultra-fine filler and a pozzolanic material that densifies the microstructure of the cured CBC 106 at the nanoscale, contributing to increased compressive strength, reduced permeability, and improved long-term durability of the hardscape installation 100.

Taken together, the eleven constituent components of Variation 1 combine to form a balanced, multi-component dry composition that delivers high compressive, tensile, and flexural strength upon activation and curing. The technical significance of the Variation 1 formulation is that it establishes the core component architecture of the CBC 106 which is a composition in which the ultrafine sand 250, cement 252, and fine sand 262 form a densely packed matrix activated by the redispersible polymer 256, the specialty cement 258, and the remaining functional additives to produce a cured substrate having the structural integrity necessary to support a broad range of HSMs 110, including heavier and more fragile materials such as travertine, porcelain, natural stone, tile, and marble. In the illustrated embodiment, Variation 1 also serves as the foundational formulation upon which each of the subsequent variations of the CBC 106 is built, with each subsequent variation introducing one or more additional components targeted to specific installation conditions or performance requirements.

FIG. 3B is a formulation table of a second variation of the CBC 106, referred to herein as Variation 2. In some embodiments, Variation 2 includes all eleven constituent components of Variation 1 (i.e., the ultrafine sand 250, the cement 252, the defoamer 254, the redispersible polymer 256, the specialty cement 258, the accelerator 260, the fine sand 262, the densifier 264, the pozzolan 266, the sag resistance additive 268, and the micro-silica 270) present in the same respective weight percentage ranges as described above in connection with FIG. 3A. Variation 2 further includes one additional specialty additive component: an antifreeze additive 272. Because the shared components of Variation 2 are configured in substantially the same manner as those of Variation 1, they need not be described again in connection with FIG. 3B.

In the illustrated embodiment, the antifreeze additive 272 is present in an amount of about 0% to about 1%, about 0.001% to about 1%, about 0.01% to about 1%, or about 0.1% to about 1% by weight and is blended into the dry CBC 106 with the intention of assisting the activated composition to set and cure at lower ambient temperatures and/or to reduce or eliminate the deleterious effects of freeze-thaw cycling on the cured composition. In some embodiments, the antifreeze additive 272 is a sodium nitrate derivative, sodium chloride, calcium chloride, or a potash derivative. The antifreeze additive 272 operates by depressing the freezing point of the water introduced during the saturation step 216, thereby maintaining the fluidity of the activating water at sub-freezing temperatures and allowing the hydraulic chemistry of the CBC 106 to proceed normally. Additionally, in some embodiments, the antifreeze additive 272 reduces the susceptibility of the cured CBC 106 to freeze-thaw-induced microcracking by minimizing ice crystal formation within the cured matrix during repeated freeze-thaw cycling.

The technical significance of Variation 2 is that the addition of the antifreeze additive 272 adapts the CBC 106 for installation and long-term service in geographic regions subject to cold-weather conditions or seasonal freeze-thaw cycles. Without the antifreeze additive 272, hydraulic hardening of the CBC 106 can be impaired at low temperatures, and the cured composition can be susceptible to progressive frost-induced degradation over repeated freeze-thaw events. Variation 2 therefore extends the operational geographic and seasonal range of the CBC 106 while maintaining the same core compressive, tensile, and flexural strength properties established in Variation 1.

FIG. 3C is a formulation table of a third variation of the CBC 106, referred to herein as Variation 3. In some embodiments, Variation 3 includes all eleven constituent components of Variation 1 (i.e., the ultrafine sand 250, the cement 252, the defoamer 254, the redispersible polymer 256, the specialty cement 258, the accelerator 260, the fine sand 262, the densifier 264, the pozzolan 266, the sag resistance additive 268, and the micro-silica 270) present in the same respective weight percentage ranges as described above in connection with FIG. 3A. Variation 3 further includes one additional specialty additive component: a decelerator 274. Because the shared components of Variation 3 are configured in substantially the same manner as those of Variation 1, they need not be described again in connection with FIG. 3C.

In the illustrated embodiment, the decelerator 274 (a.k.a. a set retarder or retarder) is present in an amount of about 0% to about 4%, about 0.001% to about 4%, about 0.01% to about 4% or about 0.1% to about 4% by weight and is blended into the dry CBC 106 with the intention of slowing down or increasing the set time of the composition following water activation. In some embodiments, the decelerator 274 is calcium lignosulfonate, a gluconate derivative, or citric acid. The decelerator 274 operates by interfering with the early hydration reactions of the cement 252 and the specialty cement 258, thereby extending the period of time between water activation during the saturation step 216 and the onset of structural hardening of the CBC 106.

In the illustrated embodiment, note that the decelerator 274 and the accelerator 260 operate in opposition to one another in that the accelerator 260 reduces set time and the decelerator 274 extends set time. In some embodiments, the relative proportions of the accelerator 260 and the decelerator 274 within Variation 3 are adjusted to achieve a target set time appropriate for specific installation conditions.

The technical significance of Variation 3 is that the decelerator 274 provides extended working time following water activation. This is advantageous in high-temperature or high-humidity environments where the CBC 106 might otherwise set too quickly following the saturation step 216 (e.g., potentially before uniform bonding between the CBC 106 and the HSM 110 has been fully achieved across the installation area). By extending the working time of the activated CBC 106, Variation 3 preserves the ability of the installer to make final positional adjustments to the HSM 110 and to ensure uniform bonding, without sacrificing the ultimate compressive, tensile, and flexural strength properties of the cured composition.

FIG. 3D is a formulation table of a fourth variation of the CBC 106, referred to herein as Variation 4. In some embodiments, Variation 4 includes all eleven constituent components of Variation 1 (i.e., the ultrafine sand 250, the cement 252, the defoamer 254, the redispersible polymer 256, the specialty cement 258, the accelerator 260, the fine sand 262, the densifier 264, the pozzolan 266, the sag resistance additive 268, and the micro-silica 270) present in the same respective weight percentage ranges as described above in connection with FIG. 3A. Variation 4 further includes one additional specialty additive component: a coarse aggregate 276. Because the shared components of Variation 4 are configured in substantially the same manner as those of Variation 1, they need not be described again in connection with FIG. 3D.

In the illustrated embodiment, the coarse aggregate 276 is present in an amount of about 5% to about 10% by weight. The coarse aggregate 276 is blended into the dry CBC 106 as a third, larger particle size fraction that supplements the ultrafine sand 250 and the fine sand 262. The coarse aggregate 276 is distributed uniformly throughout the dry composition and becomes embedded within the cured CBC 106 matrix following activation and hardening.

In the illustrated embodiment, the coarse aggregate 276 is introduced to increase both the skeletal structure and load-bearing capacity of the cured CBC 106. By incorporating a coarser particle fraction, the aggregate forms a robust, interlocked matrix within the composition, which enhances resistance to compressive deformation under heavy surface loads and increases overall stiffness. This reduction in deflection under load minimizes the risk of cracking in the HSM 110. The technical significance of Variation 4 lies in the ability of the coarse aggregate 276 to boost compressive strength and structural rigidity beyond what is achievable with the fine-particle matrix of Variation 1 alone, making it especially suitable for installations exposed to heavy vehicular traffic or tasked with supporting unusually large or heavy HSMs 110.

FIG. 3E is a formulation table of a fifth variation of the CBC 106, referred to herein as Variation 5. In some embodiments, Variation 5 includes all eleven constituent components of Variation 1 (i.e., the ultrafine sand 250, the cement 252, the defoamer 254, the redispersible polymer 256, the specialty cement 258, the accelerator 260, the fine sand 262, the densifier 264, the pozzolan 266, the sag resistance additive 268, and the micro-silica 270) present in the same respective weight percentage ranges as described above in connection with FIG. 3A. Variation 5 further includes one additional specialty additive component: mortar fiber 278. Because the shared components of Variation 5 are configured in substantially the same manner as those of Variation 1, they need not be described again in connection with FIG. 3E.

In the illustrated embodiment, the mortar fiber 278 is present in an amount of about 0% to about 2%, about 0.001% to about 2%, about 0.01% to about 2%, or about 0.1% to about 2% by weight. The mortar fiber 278 consists of small, shredded fibers made of synthetic, steel, or natural materials that are blended dry into the CBC 106 composition. In some embodiments, the mortar fiber 278 is steel micro-fibers, polypropylene synthetic micro-fibers, or poly-vinyl alcohol (PVA) fibers. The mortar fiber 278 is distributed in a random, three-dimensional orientation throughout the dry CBC 106 matrix prior to activation and remains embedded within the cured composition following the saturation step 216 and the curing step 218.

In the illustrated embodiment, the mortar fiber 278 functions as internal micro-reinforcement within the cured CBC 106. Upon activation and curing, individual fibers of the mortar fiber 278 bridge microscopic cracks that may form within the cured matrix under applied load or thermal stress. This crack-bridging mechanism inhibits crack propagation and absorbs energy at crack tips, increasing the toughness and flexural strength of the cured CBC 106 beyond what is achievable with the cementitious matrix and aggregate components alone. In some embodiments, the mortar fiber 278 also reduces early-age plastic shrinkage cracking within the CBC 106 during the curing step 218.

The technical significance of Variation 5 is that the mortar fiber 278 imparts crack resistance and enhanced flexural performance to the CBC 106, which is particularly beneficial in installations supporting thin, brittle, or large-format HSMs 110 (e.g., travertine, porcelain, or marble) that are themselves susceptible to cracking when the underlying substrate deflects or cracks under load. By increasing the flexural toughness of the CBC 106, Variation 5 reduces the risk of substrate failure that could otherwise propagate through and fracture the HSM 110.

FIG. 3F is a formulation table of a sixth variation of the CBC 106, referred to herein as Variation 6. In some embodiments, Variation 6 includes all eleven constituent components of Variation 1 (e.g., the ultrafine sand 250, the cement 252, the defoamer 254, the redispersible polymer 256, the specialty cement 258, the accelerator 260, the fine sand 262, the densifier 264, the pozzolan 266, the sag resistance additive 268, and the micro-silica 270) present in the same respective weight percentage ranges as described above in connection with FIG. 3A. Variation 6 further includes one additional specialty additive component: a plasticizer 280. Because the shared components of Variation 6 are configured in substantially the same manner as those of Variation 1, they need not be described again in connection with FIG. 3F.

In the illustrated embodiment, the plasticizer 280 (a.k.a., superplasticizer, water reducer, or high range water reducer) is present in an amount of about 0% to about 2%, about 0.001% to about 2%, about 0.01% to about 2%, or about 0.1% to about 2% by weight and is blended into the dry CBC 106 with the intention of reducing the effective water demand of the composition upon activation during the saturation step 216. The plasticizer 280 operates by dispersing the cement particles within the activated CBC 106, reducing inter-particle friction and allowing the hydraulic reactions of the cementitious components to proceed with a lower quantity of activating water than would otherwise be required to achieve equivalent workability and bonding performance.

By reducing the effective water-to-cement ratio of the activated CBC 106, the plasticizer 280 enables the cured composition to achieve a denser, stronger matrix with improved compressive and flexural strength, reduced porosity, and enhanced long-term durability compared to equivalent formulations without a water reducer. In some embodiments, the plasticizer 280 also improves the flowability of the activated CBC 106, enabling more complete and uniform bonding at the interface between the CBC 106 and the underside of the HSM 110.

The technical significance of Variation 6 is that the plasticizer 280 allows the CBC 106 to achieve superior mechanical performance and reduced permeability with a lower quantity of activating water. This is advantageous in installation environments where precise control of water saturation is important, where the quantity of water available for the saturation step 216 is limited, or where minimizing excess water in the cured system is desirable for long-term durability of the hardscape installation 100.

Taken together, Variations 1 through 6 of the CBC 106, as shown in FIGS. 3A–3F, collectively demonstrate that the multi-component architecture of the CBC 106 is extensible and adaptable to a wide range of geographic, environmental, and structural installation requirements. In some embodiments, two or more of the additional specialty additive components described in Variations 2 through 6 (i.e., the antifreeze additive 272, the decelerator 274, the coarse aggregate 276, the mortar fiber 278, and the plasticizer 280) are combined within a single formulation of the CBC 106 to simultaneously address multiple installation challenges. In some embodiments, the manufacturing of the CBC 106 is performed to specific and highly controlled tolerances, such that the only source of material variability in the finished hardscape installation 100 is misapplication during the installation process. Furthermore, in some embodiments, the CBC 106 includes other additives, such as, for example, water insoluble polymers, chemicals of catalytic capacity to other active ingredients, and/or admixtures for altering viscosity. In addition, in some embodiments, the formulation of the CBC 106 protects embedded and adjacent metallic components (e.g., the rebar 108) from corrosion.

The performance advantages of the CBC 106 are illustrated by comparing the CBC 106 against the primary conventional installation methods used in the hardscape industry, each of which addresses some, but not all, of the technical challenges presented by paving stone and surface material installation.

A first conventional method involves laying the hardscape surface material directly on compacted earth or a standard paver base material, without any cementitious or polymeric layer interposed between the sub-base and the hardscape surface material. While this method is cost-effective and fast, and allows for adequate water drainage, the absence of any binding or structural base layer leaves the hardscape surface material highly susceptible to sinking, shifting, and lifting under applied loads. Additionally, without a solid consolidated layer beneath the hardscape surface material, this method provides no meaningful resistance to vegetation growth, insect colonization, or water wash-out at the sub-base level, each of which can progressively destabilize the installation over time. This method is not suitable for use with heavier or more fragile hardscape surface materials 110, such as travertine, porcelain, natural stone, tile, or marble, which require a sufficiently stiff and strong substrate to prevent cracking and failure.

A second conventional method involves applying a single-component base material (e.g., joint sand, mason sand, ordinary Portland cement, or Portland limestone cement) as a layer upon which the hardscape surface material is set. While relatively cost-effective and fast, single-component materials of this type exhibit low compressive and flexural strength when used in isolation and are prone to fracturing and dispersing under load, resulting in sinking, shifting, and lifting of the hardscape surface material. The low structural integrity of these materials likewise renders them ineffective at resisting vegetation growth, insect colonization, and water wash-out. This method is not suitable for heavier or fragile hardscape surface materials.

A third conventional method involves pouring ready-mixed concrete slabs of predetermined size as a structural base, over which the hardscape surface material is subsequently installed. While this method provides substantial compressive and flexural strength and effectively resists vegetation growth, insect colonization, and water wash-out, it introduces significant cost, time, and logistical burdens. The concrete slab requires a minimum curing interval, for example, at least fourteen days, before the hardscape surface material can be installed, extending the overall project timeline substantially. Additionally, concrete slabs are susceptible to leveling problems that can impair drainage, and require supplemental adhesive products to bond the hardscape surface material to the slab surface, adding further cost and process complexity. The environmental footprint of this method is also substantially larger than other methods due to the quantities of cementitious material and associated chemicals required.

A fourth conventional method involves using bagged concrete mix products as a base material. While relatively cost-effective and fast, bagged concrete mix products are commonly manufactured with low-quality materials and are subject to significant unit-to-unit variability due to inconsistent quality control. These products routinely exhibit inadequate compressive and flexural strength, resulting in structural failure of the base layer under load, and consequent sinking, shifting, and lifting of the hardscape surface material. The low strength and structural inconsistency of bagged concrete mix products also renders them ineffective at resisting vegetation growth, insect colonization, and water wash-out, and they are not suitable for heavier or fragile hardscape surface materials.

A fifth conventional method involves rigid plastic underlayment base panels placed atop the prepared ground, with sand layers applied above the panels on which the hardscape surface material is set. While this method provides reasonable product consistency and adequate water drainage, the plastic panel systems present several limitations. The panels are significantly more costly than other base materials, are difficult to fit precisely to irregular installation areas (requiring field modifications that add time and cost), and present an uncertain long-term environmental impact due to the potential for chemical leaching from plastic and petrochemical materials into the surrounding soil and groundwater. Sand layers applied above the panels do not effectively prevent vegetation growth or insect colonization, and the flexibility of the panels renders this method unsuitable for heavier or fragile hardscape surface materials or high-traffic applications.

A limitation shared by substantially all of the foregoing conventional methods is the inability to provide sufficient compressive and flexural strength to support heavier, thinner, or more structurally sensitive hardscape surface materials (e.g., travertine, porcelain, natural stone, tile, and marble) which have little inherent flexural strength and require a rigid, high-strength substrate to prevent cracking and structural failure under load. In contrast, the CBC 106 is formulated to provide high compressive, tensile, and flexural strength through the combination of the ultrafine sand 250, cement 252, fine sand 262, specialty cement 258, redispersible polymer 256, and the supplementary performance additives described above in connection with FIGS. 3A–3F. The CBC 106 forms a solid, monolithic substrate upon curing that effectively resists movement of the HSM 110, vegetation growth, water wash-out, and insect colonization throughout the service life of the hardscape installation 100. Furthermore, the CBC 106 is applied in its dry, unactivated state and activated in situ by water saturation following placement of the HSM 110, as described above in connection with FIG. 2, which enables installation timelines comparable to the simplest conventional methods while achieving a level of structural performance previously available only through significantly more costly, time-consuming, and logistically complex approaches. The CBC 106, due to its chemistry and placement process, allows water to appropriately drain and prevents standing pools and the damage that can result therefrom. The CBC 106 additionally does not contain leaching plastic or petrochemical ingredients, minimizing its long-term environmental impact relative to plastic panel-based methods. In some embodiments, subsequent rainfall or water exposure following the initial saturation step 216 activates any residual dry CBC 106 not fully reached during installation, further consolidating the cured substrate and reducing the potential for water wash-out over time.

It is well understood that methods that include one or more steps, the order listed is not a limitation of the claim unless there are explicit or implicit statements to the contrary in the specification or claim itself. It is also well settled that the illustrated methods are just some examples of many examples disclosed, and certain steps may be added or omitted without departing from the scope of this disclosure. Such steps may include incorporating devices, systems, or methods or components thereof as well as what is well understood, routine, and conventional in the art.

The connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C. The terms “couples,” “coupled,” “connected,” “attached,” and the like along with variations thereof are used to include both arrangements wherein two or more components are in direct physical contact and arrangements wherein the two or more components are not in direct contact with each other (e.g., the components are “coupled” via at least a third component), but still cooperate or interact with each other.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

I claim:

1. A dry cementitious base composition for installation of hardscape surface materials, comprising:
ultrafine sand in an amount of about 40% to about 60% by weight;
cement in an amount of about 25% to about 45% by weight;
fine sand in an amount of about 10% to about 20% by weight;
a redispersible polymer in an amount of about 1% to about 3.5% by weight;
a specialty cement in an amount of about 1.5% to about 4.5% by weight;
a defoamer in an amount of 0% to about 2% by weight;
an accelerator in an amount of 0% to about 2% by weight;
a densifier in an amount of 0% to about 2% by weight;
a pozzolan in an amount of 0% to about 4% by weight;
a sag resistance additive in an amount of 0% to about 1% by weight; and
micro-silica in an amount of 0% to about 4% by weight.

2. The dry cementitious base composition of claim 1, wherein the composition is configured for dry placement over a prepared substrate and activation by water saturation following placement of surface materials thereon.

3. The dry cementitious base composition of claim 1, wherein the cement comprises at least one of ordinary Portland cement (OPC) and Portland limestone cement (PLC).

4. The dry cementitious base composition of claim 1, wherein the defoamer is in an amount of about 0.001% to about 2% by weight.

5. The dry cementitious base composition of claim 1, wherein the accelerator is in an amount of about 0.001% to about 2% by weight.

6. The dry cementitious base composition of claim 1, wherein the densifier is in an amount of about 0.001% to about 2% by weight.

7. The dry cementitious base composition of claim 1, wherein the pozzolan is in an amount of about 0.001% to about 4% by weight.

8. The dry cementitious base composition of claim 1, wherein the sag resistance additive is in an amount of about 0.001% to about 1% by weight.

9. The dry cementitious base composition of claim 1, wherein the micro-silica is in an amount of about 0.001% to about 4% by weight.

10. The dry cementitious base composition of claim 1, further comprising an antifreeze additive in an amount of about 0.001% to about 1% by weight.

11. The dry cementitious base composition of claim 1, further comprising a decelerator in an amount of about 0.001% to about 4% by weight.

12. The dry cementitious base composition of claim 1, further comprising a coarse aggregate in an amount of about 5% to about 10% by weight.

13. The dry cementitious base composition of claim 1, further comprising a mortar fiber in an amount of about 0.001% to about 2% by weight.

14. The dry cementitious base composition of claim 1, further comprising a plasticizer in an amount of about 0.001% to about 2% by weight.

15. A method of installing hardscape surface materials over a prepared substrate, comprising:
compacting and screeding a sand base layer over a prepared ground substrate;
distributing a dry cementitious base composition over the compacted sand base layer, wherein the composition comprises ultrafine sand, cement, fine sand, a redispersible polymer, a specialty cement, and one or more additives selected from the group consisting of a defoamer, an accelerator, a densifier, a pozzolan, a sag resistance additive, and micro-silica;
lightly compacting and screeding the distributed composition to achieve a level surface;
laying surface materials on top of the dry cementitious base composition in a desired pattern;
setting a border element around the surface materials; and
saturating the surface materials with water to activate the cementitious base composition and initiate bonding and setting thereof.

16. The method of claim 15, further comprising positioning rebar atop the distributed dry cementitious base composition.

17. The method of claim 15, wherein the dry cementitious base composition comprises:
the ultrafine sand in an amount of about 40% to about 60% by weight;
the cement in an amount of about 25% to about 45% by weight;
the fine sand in an amount of about 10% to about 20% by weight;
the redispersible polymer in an amount of about 1% to about 3.5% by weight;
the specialty cement in an amount of about 1.5% to about 4.5% by weight;
the defoamer in an amount of 0% to about 2% by weight;
the accelerator in an amount of 0% to about 2% by weight;
the densifier in an amount of 0% to about 2% by weight;
the pozzolan in an amount of 0% to about 4% by weight;
the sag resistance additive in an amount of 0% to about 1% by weight; and
the micro-silica in an amount of 0% to about4% by weight.

18. The method of claim 17, wherein:
the defoamer is in an amount of 0.001% to about 2% by weight;
the accelerator is in an amount of 0.001% to about 2% by weight;
the densifier is in an amount of 0.001% to about 2% by weight;
the pozzolan is in an amount of 0.001% to about 4% by weight; and/or
the sag resistance additive is in an amount of 0.001% to about 1% by weight.

19. The method of claim 17, wherein the dry cementitious base composition further comprises one or more specialty additives as follows:
an antifreeze additive in an amount of about 0.001% to about 1% by weight;
a decelerator in an amount of about 0.001% to about 4% by weight;
a coarse aggregate in an amount of about 5% to about 10% by weight;
a mortar fiber in an amount of about 0.001% to about 2% by weight;
a plasticizer in an amount of about 0.001% to about 2% by weight; and/or
a micro-silica in an amount of 0.001% to about 4% by weight.

20. A method of forming a hardscape installation capable of supporting travertine, porcelain, natural stone, tile, or marble surface materials, comprising:
applying a compacted sand layer over a prepared ground substrate;
dry-applying over the sand layer a multi-component cementitious base composition comprising ultrafine sand, cement, fine sand, a redispersible polymer, a specialty cement, a densifier, a pozzolan, and micro-silica;
screeding the dry cementitious base composition to a uniform depth;
placing the surface materials on top of the dry cementitious base composition; and
activating the composition by saturating the surface materials with water and allowing the composition to cure to form a solid substrate.
